(19) United States
(12) Patent Application Publication
(10) Pub. No.: US 2003/0212762 A1
(43) Pub. Date: Nov. 13, 2003

(54) Delivery system and method for uniform display of supplemental content

(75) Inventors: Craig Barnes, Portland, OR (US); Eric Hayes, Tigard, OR (US)

Correspondence Address: STOEL RIVES LLP, 900 SW FIFTH AVENUE, SUITE 2600, PORTLAND, OR, 97204, US

(73) Assignee: You Networks, Inc., Portland, OR (US)

(21) Appl. No.: 10/142,632

(22) Filed: May 8, 2002

(51) Int. Cl. G06F 15/16

(52) U.S. Cl. 709/219

(57) ABSTRACT

A system of the present invention receives and stores supplemental content for display to an end user upon request. The supplemental content (450) corresponds to a known digital content substrate (410). A unique identifier can be determined via a checksum procedure to identify the known digital content substrate (410). A software routine (404) then assesses an item presented to an end user for display. A candidate identifier can be determined for the display item and matched to the stored unique identifier to identify the display item as the known digital content substrate (410). An interactive indicator symbol (414) can signify availability of supplemental content (450), and uniformly formatted supplemental content (450) can be displayed in a substantially instantaneous manner in response to the user interacting with the interactive indicator symbol (414).

### COPYRIGHT NOTICE

© 2002 You Networks, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d), (e).

### TECHNICAL FIELD

The present invention relates to systems and methods for delivery and display of requested supplemental content to a remote end user over a data communications network.

### BACKGROUND OF THE INVENTION

With existing networking technologies, information can be provided over data communications networks to end users operating a variety of electronic devices designed to receive and display data. As the ability to provide vast amounts of data has increased over time, the challenge has shifted away from merely trying to send data, toward trying to send and display the data in the most efficient and desirable way. The term “content” is used herein to refer to data of all types as presented or displayed to the end user.

Unfortunately, due in large part to the vast number and variety of data sources available, content is often displayed either inconsistently, or in a way that is convenient or desirable for the content provider and not necessarily for the end user. Each content provider can provide and format his content in a different way, unique only to him. Consequently, many end users become frustrated with the inconsistency, and accessing content displays becomes an arduous task. The end user must acquaint himself with the display format for each new data provider. Frequently, the information the end user desires most is not even readily available.

The World Wide Web (“Web”), as a display network for the Internet, illustrates the problem of inconsistent content display. Practically every one of the roughly 25 million existing Web sites has a somewhat different layout and configuration. This problem is further exacerbated by the formatting and display changes that must be made to accommodate the increasing variety of display devices that can now access the Web (computers, mobile phones, PDAs, hand-held devices, interactive televisions, etc.). As the end user encounters each new Web page, the user must learn each layout anew. Finding desired information on an unfamiliar Web site, such as contact information for the page owner or publisher, can often take more time than the user would prefer to allocate.

Inconsistent content display is only one example of the myriad of inefficiencies that can result from a general failure to consider the perspective or desires of end users. Generally, end users have three main concerns: they do not want to be interrupted; they want more key information readily available; and they do not like to wait. While an end user is viewing some piece of display content, such as a Web page, for example, the user is often presented with an opportunity to access supplemental content. This supplemental content may be related or unrelated to the display content. An example of this is the prolific placement of graphic elements, such as banner advertisements, tile advertisements, affiliate bugs, or the like, on Web sites. In the present nomenclature, the concepts of display content and supplemental content may be nested. For example, advertisement graphics, which may be supplemental content to a Web site, can also represent display content themselves. By clicking on an ad, the user can access further supplemental content, typically in the form of a new Web page to which the ad links.

As a practical matter on the Web, banner ads and other traditional offers to access supplemental content are rarely selected by end users. In part, this is because they are not very informative. It is frequently difficult to tell who is providing the supplemental content or what the supplemental content actually is. If the user selects the ad, he typically will be directed to a new Web site, where he will have to comprehend how the content on that site is organized. After becoming acquainted with the content of the new site, he must then navigate back to his initial site. All of this takes time, and end users do not want to experience that much of an interruption. Content providers have tried to avoid requiring the end user to navigate to new sites by presenting additional windows or pop-up information to the user. Unfortunately, the user is exposed to this information without affirmatively requesting it. This creates ever greater interruption and frustration for the end user who must then close the additional unsolicited windows, applets, ads, etc.

To address the aforementioned problems, many companies have developed technologies to improve the likelihood that an end user will choose to access supplemental content. While each of these attempts have provided some utility, none of them have been able to provide a complete solution from the point of view of the content providers and the end user. These prior art technologies can be grouped based on common characteristics. The following discussion highlights some of the most noteworthy efforts, and discusses their shortcomings.

A first class of systems targets specific content to particular users whom they determine may be receptive to that type of content. In the context of the Web, ad-serving companies illustrate this implementation. Patents, such as U.S. Pat. Nos. 5,948,061 and 6,026,368, describe systems and methods for targeting specific content to a particular end user. While ad serving is a useful concept and helps avoid the problem of a user being inundated with content he does not find interesting, it does nothing to solve the problems an end user encounters due to lack of uniformity in displayed content and inability to find key information on-demand without interrupting the current task. Furthermore, selecting ads still significantly interrupts the end user from his current task.

A second group of systems provides reporting and marketing services. Similar to ad servers, reporting or marketing services are aimed at helping data providers send specific content to a receptive user. These service providers take advantage of the interactive nature of new display technologies and allow content providers to profile, target, and personalize messages. They track and report which ads are most popular with which users. While these methods gather useful statistics and user information, they do not actively improve the content display experience for the end user. Their contribution is a cumulative and iterative one, essentially involving trial and error. U.S. Pat. Nos. 6,112,238 and 6,317,787 represent these types of technologies.

With a focus on providing a more interactive experience for end users, some solution providers enable end users to save display content, such as banner ads, into a designated personal storage area. This allows the user to view the ads later, rather than interrupt what he is doing when the ad is presented. While this technology has benefits, including reducing or deferring the interruption encountered by an end user, it is only a partial solution. It does not provide familiar, consistent displays of content or help the user obtain key information immediately upon demand. Because the user cannot quickly view the information, he may also frequently have to save an ad without knowing if the corresponding supplemental information will actually be useful. Ultimately, the user still must navigate to and from each site corresponding to each saved ad in order to access the supplemental content.

The term “rich-media company” describes technology providers attempting to deliver dynamic, richer, more robust content. This technology is reflected in patents such as U.S. Pat. Nos. 5,796,952 and 6,317,761. Rich-media companies typically embed or deliver code or programming instructions in the display content itself. In this context, the display content is called a “creative.” These companies use a combination of display technologies and delivery mechanisms to generate a dynamic content display for the end user, often including animation and audio. While they are sometimes entertaining, these technology solutions are time- and cost-intensive. Additionally, because they require code in the creative itself, these solutions are of no benefit to preexisting display content. They must be created and embedded for each new creative deployed. Additionally, the dynamic and varied displays generated by rich-media companies tend to distract and interrupt the end user, rather than provide an unobtrusive solution for obtaining key information on demand. The inconsistency of the displays makes it difficult for the user to locate desired information quickly. As an additional disadvantage, Rich-media companies often employ Java applets that require loading time. The slow response and delivery forces the end user to wait, resulting in significant frustration.

“Text-Based Information Pop-ups” are technology solutions that allow users to select textual words in a screen display. The selectable words are either predefined, or ascertainable via a text-parsing algorithm. The words are typically highlighted or underlined so as to be readily ascertainable to the end user. When selected by a mouse, additional information pertaining to the selected word is presented to the user in a transient pop-up window, typically near the predefined text. The additional information can include a translation or definition of the word, etc. Unfortunately for the end user, the additional information is not always provided in a uniform display. Also, such systems have only been operable with text.

Because text-based information pop-ups operate upon natural-language, nonproprietary words, they must inherently remain generic with respect to the information they provide. Any of several, often competitive, entities may have information they would like to associate with the predefined term. It becomes impractical to provide information that is specific to any one entity, at the exclusion of all others. Thus, these systems are largely inapplicable, ineffective, or controversial for uses such as marketing or advertising. To ensure fair and equitable representation of all potential entities, responsibility for defining the provided information must be overseen centrally, from a neutral perspective. Because responsibility for supplying or updating the additional content cannot be distributed, these systems suffer from high overhead and maintenance requirements. Examples of this type of technology can be found in U.S. Pat. Nos. 5,822,720 and 6,341,306.

Another interesting, but limited, technology area encompasses digital watermarking and digital tagging. These technologies help identify a particular display content. Watermarking involves changing a small portion of the digital bit order of the content in a way that is imperceptible when viewed by the human eye, but detectable by computerized readers. Similar to watermarking, tagging content involves adding a few bits to the beginning or end of a bit stream representing digital content to be used for identification purposes. The principal drawback of these technologies, however, is that they require altering the content itself. The modifications must be applied at the time of creation or before distribution of the content. There is no convenient way to apply these technologies to content that is already widely disseminated and stored remotely across a network.

While each of the aforementioned technologies has benefits, none of them provide a solution for displaying content that is beneficial and desirable for both the content provider and the end user. What is needed is a system and method that allows an end user on a data communications network to demand information or view displayed content instantly, unobtrusively, consistently, and without interrupting his current task. The present invention fulfils this need.

### SUMMARY OF THE INVENTION

The present invention encompasses a system and method for on-demand display of supplemental content to an end user on a data communications network, such as the Internet. The supplemental content correlates to a digital content substrate. Examples of digital content substrates, in the context of the Internet, include display objects such as a banner advertisement, tile advertisement, affiliate bug, streaming media or audio/video content, a Web page, an e-mail, an interactive television (“iTV”) display, or any other graphical element. The digital content substrate can comprise all or a portion of the end-user display. Throughout this specification and the appended claims, the term “display” refers to the presentation of data on an end user's electronic display device. The display device can be wired or wireless, fixed or mobile, as long it has supports connectivity to a network. The term “content” refers to the data that is displayed. Both terms are used broadly, as a “display” can include static or dynamic audio or visual presentation of a textual or graphical nature, and content refers to any displayed data, regardless of the type or purpose (e.g., informational, educational, entertaining, commercial, etc.).

Unlike prior art systems, the present invention allows the end user to view, on demand, supplemental content for one or more displayed digital content substrates without having to exit the current display. In a Web embodiment, this means that an end user can display supplemental content without having to click-through or navigate to a new Web site. The supplemental content is designed to present essential information to a user. As such, the user does not experience interruption unless he so chooses, and he is provided essential information on demand, without having to wait.

A system consistent with the present invention receives and stores supplemental content to be displayed to an end user upon request. Supplemental content corresponds to a known digital content substrate. A unique identifier, such as a graphical display element's digital fingerprint, is then determined via a checksum procedure for the digital content substrate. The unique identifier is used to identify the digital content substrate upon presentation to the end user for display.

When display items are provided to the end user, a software routine employed by the system evaluates the displayed items to identify those display items that are likely to correspond to known digital content substrates. A unique identifier is then determined for the promising display items, and the determined unique identifier is compared against the stored unique identifiers. If the determined unique identifier matches a stored unique identifier, the identity of the display item is confirmed as the known digital content substrate with the matching unique identifier.

In order to make the end user aware of the availability of the supplemental content without occluding the display of the digital content substrate itself, an interactive indicator display symbol can be used. The interactive indicator can be displayed atop the digital content substrate. Preferably, the interactive indicator is semi-transparent or displayed intermittently to avoid permanently occluding the underlying digital content substrate. The interactive indicator can be a graphical display element, or it can be presented audibly. As used throughout this specification and the attached claims, the term “atop” is meant to be interpreted broadly, and it includes an audible presentation of an interactive indicator. Although not limited to such, an audible interactive indicator would be especially useful with wireless display devices such as mobile phones, hand-held computing devices, or the like. The interactive indicator signifies the presence and availability of supplemental content corresponding to the underlying digital content substrate. If the end user selects the interactive indicator, the supplemental content is displayed in a substantially instantaneous manner. The supplemental content can be transparently transmitted to the end user's display device using background network bandwidth once the identity of the digital content substrate has been confirmed. The supplemental content can also be stored directly in cache memory to be unobtrusive, yet rapidly available for viewing when requested by the end user.

One aspect of the present invention optimizes the experience of the end user viewing the supplemental content by providing a uniform, consistent display format. Both input and output standardization help assure a consistent display of the supplemental content. Input consistency can be achieved by providing specific, structured authoring and editing tools to the supplier of the supplemental content. Providing a consistent input interface allows for supplemental content from disparate sources to be entered in a consistent manner, preserving the overall display uniformity among all display panels for supplemental content. Various modules may also be used to offer predetermined functionality operable within the formatted display panel for supplemental content. For output consistency, the supplemental content can be displayed in a standardized display panel comprising standardized subsections. Consistency in the supplemental content display panel provides overall uniformity and a reliable, familiar display experience for the end user requesting the supplemental content.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 presents a schematic of a system architecture consistent with the present invention.

FIG. 2 illustrates a system flow diagram consistent with the present invention.

FIG. 3 is a process diagram illustrating a preferred embodiment configuration with an Internet browser plug-in program as the software routine.

FIG. 4 schematically depicts a system employing the process of FIG. 3.

FIGS. 5A-5C illustrate examples of a uniformly formatted display panel for displaying supplemental content.

FIG. 6 depicts supplemental content being displayed in the display panel of FIGS. 5A-5C.

FIG. 7 exemplifies a personal content interface allowing an end user to manage saved, e-mailed, printed, or similarly selected supplemental content display panels, such as that of FIG. 6.

FIGS. 8A-8C illustrate an authoring and editing interfaces for use in standardizing the input of supplemental content for presentation to an end user.

FIGS. 9A and 9B provide examples of reporting displays summarizing user interaction with supplemental content display panels, such as the one illustrated in FIG. 6.

### DETAILED DESCRIPTION OF PREFERRED EMBODIMENTS

The present invention encompasses systems and methods for on-demand display of supplemental content to an end user on a data communications network. In a preferred embodiment of the present invention, the data communications network is the Internet and display of content occurs over the World Wide Web (“Web”). Alternative embodiments of the present invention may also be incorporated into other networks, such as telecommunications networks enabling data transfer, WAP or equivalent wireless networks, LANs, wide-area networks, or intranets. When implemented on the Web, the preferred embodiment encompasses a Web-based suite of applications. As such, Internet end users can access content related to certain products or services instantly, unobtrusively, consistently, and without interruption. The present invention may be used for technology such as on-line advertising, email, Web sites, wireless marketing, interactive television, and streaming media.

While a preferred system architecture includes proprietary technology, platforms, and supporting programs, the present invention could also be practiced using commercially available standards-based products, such as the Java 2 Enterprise Edition (J2EE) platform, JavaServer Pages (JSP), Enterprise JavaBeans (EJB), XML, and Java APIs for XML Messaging (JAXM). The system architecture provides scalability, security, and flexibility. Additionally, Java 2 Micro Edition (J2ME) can enable wireless capabilities with the present invention. Because of the system's extensibility and standardized technology, it is compatible with several ad-serving network and rich-media advertising technologies.

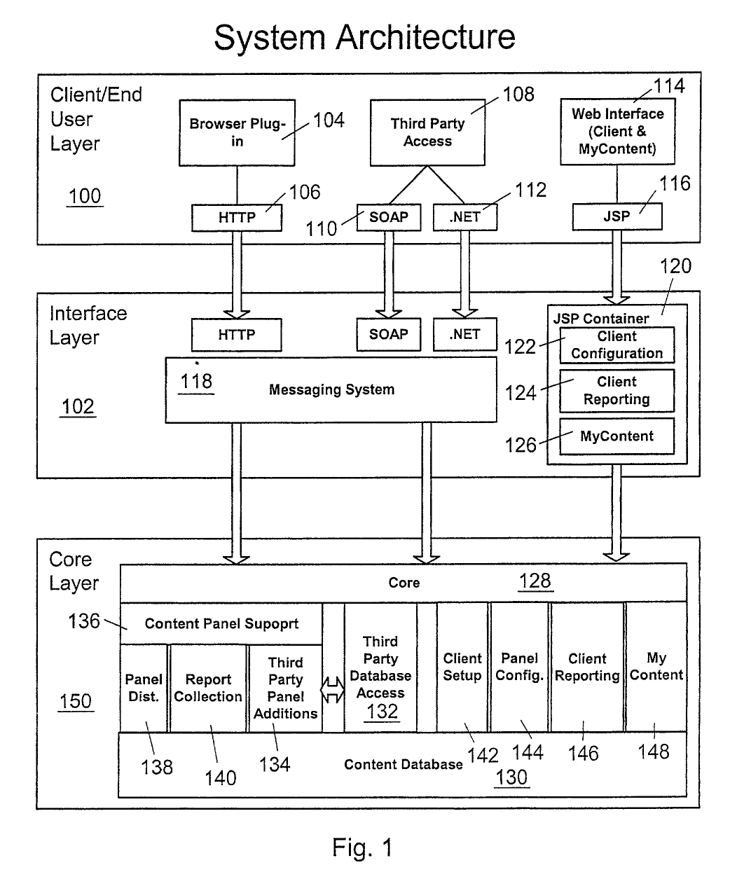

A system architecture of the present invention is illustrated in FIG. 1. FIG. 1 illustrates a client or end user layer 100, an interface layer 102, and a core layer 150. The client or end user layer 100 illustrates multiple communication points and protocols for accessing the interface layer 102. For example, the client or end user layer 100 illustrates a plug-in 104 communicating with the interface layer 102 via the hypertext transfer protocol (HTTP) 106. Third-party access 108 can use the simple object access protocol (SOAP) 110, or the .NET platform 112. Similarly, a Web interface 114 communicates with the interface layer 102 via JSP 116. Communications from the browser plug-in 104 or the third-party access 108 can access a messaging system 118 in the interface layer 102. The Web interface 114 communicating via JSP 116 accesses a JSP container 120 containing information such as client configuration 122, client reporting 124, or personalized saved information for a particular end user 126. The core layer 150 includes a core component 128, as well as a proprietary content database 130. A third-party database 132 can also be accessed for pertinent information. An example of pertinent third-party information would be for the addition of a third-party content panel 134, or a data conduit to access an external data source. The core 128 also provides content panel support 136, which includes panel distribution 138, report collection 140, and, optionally, the third-party panel additions 134. Additional information such as client setup 142, content panel configurations 144, client reporting 146, and personalized stored information 148 are also managed by the core 128 with access to the content database 130.

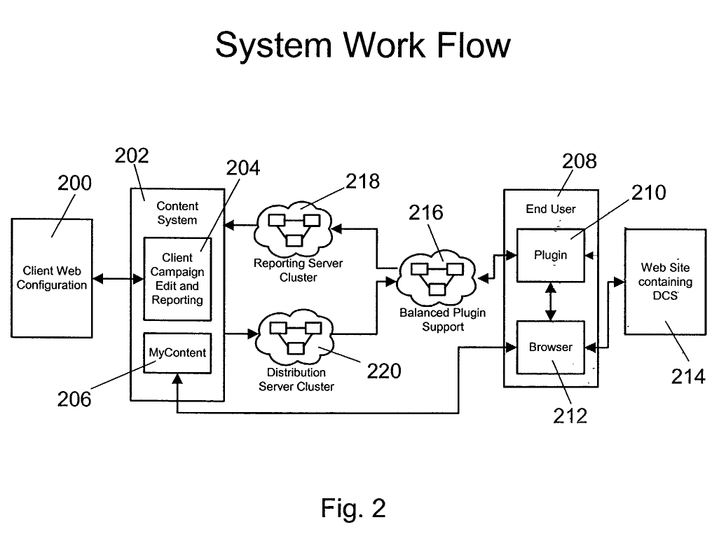

As discussed in more detail below, a software routine, preferably comprising a plug-in installed on an end user's system, can be used to recognize a digital content substrate by a unique identifier. A preferred embodiment of the present invention determines a digital fingerprint from the data bits comprising the digital content substrate to serve as the unique identifier. After recognizing and identifying the digital content substrate, supplemental content is made available to the end user by the plug-in. A system workflow for the Web-based preferred embodiment of the present invention is illustrated in FIG. 2.

In FIG. 2, a client system 200 operating a Web browser program is coupled to a content system 202 including a client-campaign editing and reporting component 204 and a personal content component 206. The personal content component 206 reflects information or content that was saved, printed, e-mailed, or otherwise selected by an end user 208. The end-user system 208 operates a Internet Web browser program 212 employing a plug-in 210. The browser 212 displays content accessed from a Web site 214. The Web site 214 can also supply the digital content substrate for the present invention.

The system workflow of FIG. 2 also illustrates balanced plug-in support 216, reporting server cluster 218 and a distribution server cluster 220. The workflow process proceeds from the distribution server cluster 220 to the balanced plug-in support 216, which supports the plug-in 210 installed at the end user system 208. The workflow from the balanced plug-in support 216 flows to the reporting server cluster 218 which is coupled to the content system 202. The reporting server cluster 218 can gather and assemble information from the plug-in 210 at the user system 208 and provide the useful information via the content system 202 to the client Web configuration 200. This output can be in the form of graphs, charts, statistics, raw-log data, or other useful information.

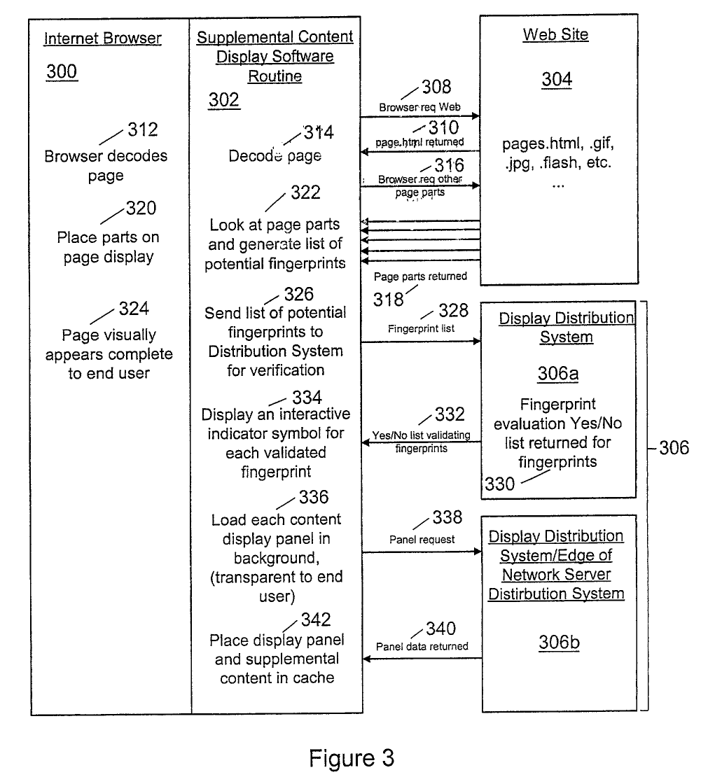

FIG. 3 illustrates a communications flow diagram for the Web-based preferred embodiment of the present invention. FIG. 3 illustrates an Internet browser 300 coupled with a supplemental content display software routine 302. The Internet browser 300 and the software routine 302 are depicted as coupled to signify that the preferred embodiment includes a plug-in installed at the Internet browser program. However, alternative embodiments to the plug-in configuration illustrated in FIG. 3 may also be adopted consistent with the present invention. These would include providing the software routine logic for supplemental content display through JavaScript code embedded in the digital content substrate, or code embedded with sophisticated or content-rich Web sites. These alternative embodiments will be discussed further below.

FIG. 3 also presents a distribution system 306. Due to the scalability of the present invention, the distribution system may be as simple as a single server or as complicated as an edge-of-network distribution cluster such as those commercially available through Akamai, Inc. The functionality of the display distribution system 306 may also be divided into an initial handling component 306a for the distribution system and a scalable component 306b, which may involve the edge-of-network server distribution system. Edge-of-network servers may also be made available only for high-bandwidth uses of the system. The concept of the scalable distribution system 306 will also involve the incorporation of load-balancing machines responsible for coordinating communications with the software routine 302. This allows for versioning control and effective management of expiration dates for the content. The display distribution system 306 may also be responsible for business logic designed to determine when content panels for supplemental content are updated to the system. High-end services can include frequent updates.

A Web site 304 can include multiple components, such an HTML page file and various graphics files (.gif, .jpg, flash, etc.). The communication flow path begins when the Internet browser 300 requests a Web page 308 from the Web site 304. In response to the request, an HTML file is returned 310. The browser decodes the HTML file 312, as does the software routine 314. The browser then requests the individual components of the Web page 316 from the Web site 304, and these components are returned to the browser 318. Components of a Web site can include graphics, links to external sources (such as a banner ad from an ad server), flash or streaming media, audio files, etc. The browser places the components at their respective locations on the Web page 320, and the Web page appears to be substantially complete 324. The software routine 302 analyzes the components of the Web page and generates a list of potentially identifiable digital fingerprints 322 serving as unique identifiers for the components of the page.

In order to afford a significant number of unique identifiers for digital content substrates, a presently preferred embodiment employs a 64-bit digital fingerprint for the unique identifier. The digital fingerprint can be determined using various checksum procedures known to those of skill in the art. Bit manipulation procedures of knowledge to those skilled in the art may be employed to ensure a unique 64-bit identifier can be determined for all types or sizes of graphic elements. For small graphical elements represented by too few bits to conduct the checksum procedure, the bits can be repeated and concatenated until the total bit value is large enough to extract a 64-bit digital fingerprint. Additionally, as will be obvious to those skilled in the art, unique identifiers other than the presently preferred 64-bit digital fingerprint could also be used. For example, by increasing the size of the unique identifier to 128 bits, the likelihood of selecting a redundant identifier among various digital content substrates decreases significantly. As will be obvious to those skilled in the art, a variety of suitable checksum or other bit manipulation procedures could be used alternatively or additionally to determine a unique identifier.

Continuing with FIG. 3, the software routine 302 sends the list of potential fingerprints 328 to the distribution system for verification 326. The fingerprint list 328 is received by the display distribution system 306a, and the fingerprints are matched against a list of known fingerprints (previously generated in the same manner as described above for known digital content substrates). Validation results 332 are then returned from the distribution system 306a to the software routine. If the fingerprint of the page component matches a fingerprints stored at the distribution system 306a, the page component is identified as the digital content substrate associated with the corresponding matched fingerprint. The software routine 302 then displays an interactive indicator symbol for each validated fingerprint 334. The preferred location for displaying this symbol is atop the display component (i.e., the identified digital content substrate). At this point, the software routine loads a supplemental content display panel template in the background of the Internet browser's communication session 336. This process is preferably transparent to the end user. A panel request 338 is then received by the distribution system or alternatively, the edge-of-network server distribution system 306b. An edge-of-network server distribution system may be employed for optimization and accelerated delivery of content. The panel content is returned 340 to the software routine, which stores the completed display panel, including the supplemental content 342, in cache memory. The completed display panel can be stored in browser cache, a separate or specifically designated cache location, disk storage, or any other suitable storage location.

The preceding description with respect to FIG. 3 depicts a communication flow where the software routine comprises a plug-in installed at the user's system. The preferred embodiment employs a plug-in for flexibility. The plug-in can be programmed in any suitable programming language known to those skilled in the art. The preferred embodiment adopts an ActiveX component plug-in. The preferred embodiment of the plug-in also typically involves two components. The first is a 6K-byte ActiveX component, which simply downloads the plug-in installer. This component lives its entire life in the background. Once the installer component is downloaded, it deletes the 6K-byte ActiveX component. It then communicates periodically with the distribution servers to obtain a manifest or index of components that need to be downloaded to assemble the current version of the completed plug-in. This installer component remains active with the plug-in to facilitate auto updating and versioning control. By repeatedly accessing distribution servers, the installer component will always make sure that the plug-in has the most recent downloaded manifest or index of components and content. Any portion of the plug-in that needs updating can be automatically downloaded.

While the presently preferred embodiment of the invention adopts a browser-integrated plug-in, other software routines may be implemented. For example, a JavaScript file can be embedded in the digital content substrate itself. When the browser downloads the digital content substrate image, the interpreted JavaScript can cause the downloading and display of the indicator symbol and supplemental content in a manner similar to the plug-in. The main difference between the plug-in and the JavaScript file, however, is that the JavaScript file is embedded into the digital content substrate itself. Accordingly, the JavaScript file possesses the identify of the digital content into which it is embedded. A digital fingerprint can also be embedded directly with the digital content substrate. The JavaScript can use the embedded fingerprint to request the supplemental content for the digital content substrate.

If the end user already has a plug-in installed and an embedded JavaScript file is encountered, the plug-in can take over control and handling of the digital content substrate. This allows for optimization based on the increased flexibility of the ActiveX component of the plug-in. While having the plug-in assume implementation control could be accomplished by the plug-in setting a JavaScript variable in the file, the JavaScript still would have to be downloaded. A preferable method has the plug-in establish control while avoiding the unnecessary use of bandwidth or resources to download, interpret, or execute the JavaScript file. In a presently preferred method for assuming control from the JavaScript, the plug-in checks the scripts list on a downloaded Web page for a particular type of JavaScript (e.g., one that would display the supplemental content for a digital content substrate). If that type of JavaScript is detected, the plug-in replaces the reference to that script in the list with a reference pointing to an alternate script defined as a “null terminating string.” The result is that the browser does not load the initial JavaScript file at all. As an additional layer of control, the HTML file stored in memory (such as browser cache) can be manipulated to remove the references to the JavaScript. This would allow the plug-in to retain control in the event of a soft refresh of the browser contents (such as when a user selects a “refresh” button).

In addition to the plug-in and embedded script file embodiments, other software routine delivery mechanisms may be adopted. One example is embedding code in the creative unit itself. Whether an email, advertisement, or Web site, a miniscule file of JavaScript code can be embedded in the actual object. Additionally, if the digital content substrate is an advertising object, such as a banner ad, the software routine can be delivered by an advertising network. This alternative embodiment would operate under the same principle as standard ad-serving applications. The Web page would download a link to an external third-party server that would then supply the content. The advertising network can also supply the software routine necessary for viewing the supplemental content. As another embodiment, the software routine may be delivered by a content site itself. Premier, content-rich Web sites can easily enable an entire site to be a supporting environment for the display of supplemental content consistent with the present invention.

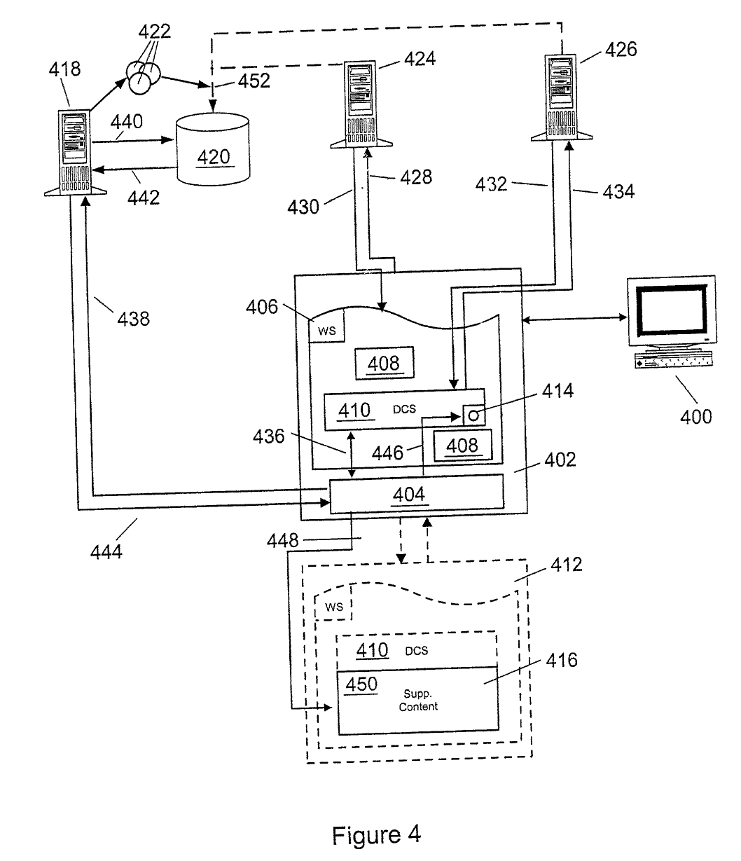

FIG. 4 schematically illustrates the relationship among the components of a preferred system embodying the present invention. An end user operates an electronic display device 400. This device can include any of several Internet or networking technology devices that allow for the display of content. This could include a laptop computer, a desktop computer, a handheld device, a PDA, a Web phone, an interactive TV, or similar device. The electronic device 400 operates a Web browser 402 that displays a Web page 406. The Web page 406 includes one or more content items 408. The Web page 406 also includes a digital content substrate 410 for which supplemental content is available. The supplemental content 416 is stored in cache, disk, or other memory 412 for the user display device 400. The browser 402 also includes a plug-in 404 comprising a software routine of the present invention. The end-user display device 400, via the browser 402, communicates with or receives information from various servers. These include a supplemental content provider 418 as well as the Web site content provider 424.

Optionally, or additionally, an ad server 426 may be incorporated into the system. As will be readily ascertainable to those skilled in the art, the server functions may be combined or additional server added while still remaining consistent with the present invention. In FIG. 4 the supplemental content server 418 provides one or more modules 422 for use by the Web site content server 424 or ad server 426. These modules afford predefined functionality and can be used for such things as reporting, tracking, deployment of panels, etc. The supplemental content server 418 also maintains a database 420 for storing supplemental content for known digital content substrates, as well as corresponding identification fingerprints. The supplemental content can be supplied from the content or ad servers 424 or 426 to the database 420 of the supplemental content server 418. The broken arrows 452 in FIG. 4 conceptually indicate the content server 424 or ad server 426 as the originators of the supplemental concept. For simplicity reasons, the concept of distributed servers has been omitted from FIG. 4; however, the supplemental content could be served from any of several distribution system servers, including edge-of-network servers or even peer-to-peer servers. Such modifications would provide flexibility for optimization, scalability, or improved performance.

The various components of FIG. 4 integrate in the following manner. The Web browser 402 first begins by accessing a content server 424 with a Web-page request 428 via standard HTTP communications. The Web content server 424 then responds to the request 430 by providing the Web site 406, including the content 408. The Web content server may provide the digital content substrate 410, or the digital content substrate 410 may come from an ad server independent of and external to the Web content server. In the implementation with the ad server 426, the Web server 424 sends a link that instructs the browser to retrieve the digital content substrate 410 from the ad server. The link points 434 the ad server 426, which then responds 432 by providing the actual ad representing the digital content substrate 410. As discussed with respect to FIG. 3, the plug-in 404 analyzes the components of the Web site 406 to detect the presence of a known digital content substrate 410. Optimization parameters can be employed. For example, if a display component is either very large or very small, the plug-in 404 may be instructed to ignore it. Similarly, the plug-in 404 may be programmed to only analyze display components that have a particular dimension. With this optimization, a plug-in 404 can be fine-tuned to look for only banner ads, which may have a standard shape, size or location. The plug-in 404 determines a fingerprint for any display component likely to represent a known digital content substrate. The fingerprints can then be sent 438 to the supplemental content server for validation. The supplemental content server 418 checks 440 the fingerprints against the database 420 of known fingerprints. Validated matches 442 are returned to the supplemental content server 418. Confirmation 444 is transmitted to the plug-in 404. Alternatively, the plug-in may have a locally stored array of known valid fingerprints, and the matching procedure may be accomplished locally without having to access the remote server.

Once the plug-in has a confirmed match for a fingerprint, the digital content substrate 410 is identified. At that time, an interactive indicator symbol 414 can be displayed atop the digital content substrate 446. The presently preferred method for displaying the interactive indicator symbol is by having the plug-in 404 cause a new instantiation of an overlaying browser window. If JavaScript is being used, rather than a plug-in, a transparent DHTML window can be generated for the browser 402. Employing either embodiment, the interactive indicator symbol can be displayed to appear atop the digital content substrate. Preferably, the interactive indicator symbol is substantially transparent or displayed intermittently with a dynamic display so as not to unduly occlude the digital content substrate.

When the plug-in 404 has identified the digital content substrate 410, it also stores a corresponding supplemental content display panel 416 in local cache 412. Preferably, the supplemental content display panel 416 is sized and positioned adjacent to the digital content substrate 410 so that they appear to be one contiguous display object. However, alternate arrangements can also be used. For example, if the digital content substrate 410 is located near the visual edge of a display, the supplemental content display panel 416 can be alternatively positioned to ensure that the entire supplemental content display panel 416 can be viewed. Also, the supplemental content display panel 416 may be a different size than a large- or small-sized digital content substrate 410. In either of these cases, the supplemental content display panel 416 may not appear to be a contiguous display object with the digital content substrate 410. The actual supplemental content 450 can be added to the supplemental content display panel 416 in the background, transparent to the user. This information can be downloaded from the supplemental content server or from one or more distributed or edge-of-network servers. When the supplemental content is stored in cache 412, versioning or expiration information may also be included. When the plug-in 404 is instructed to display the supplemental content 450 in response to end users selecting the interactive indicator symbol 414, the plug-in 404 will display a version of content that has been maintained current in cache.

Maintaining updating of the cache content can be accomplished at the time the supplemental content server 418 returns confirmation 444 for the fingerprints 438. In addition to determining if each fingerprint is recognized, the most recent version or validity date of the supplemental content can also be provided to the plug-in. If the proper version of the supplemental content is already in cache, no further download of supplemental content is necessary. If the version is outdated or stale, or if there is no version of the supplemental content in cache, the new supplemental content will be requested from the supplemental content server 418. If the version or expiration date are acceptable, the content display panel 416 is served from cache in a practically instantaneous manner and no further network bandwidth is used. In an alternative embodiment using JavaScript, as opposed to a plug-in, the JavaScript relies on browser caching to cache the supplemental content display panel 416.

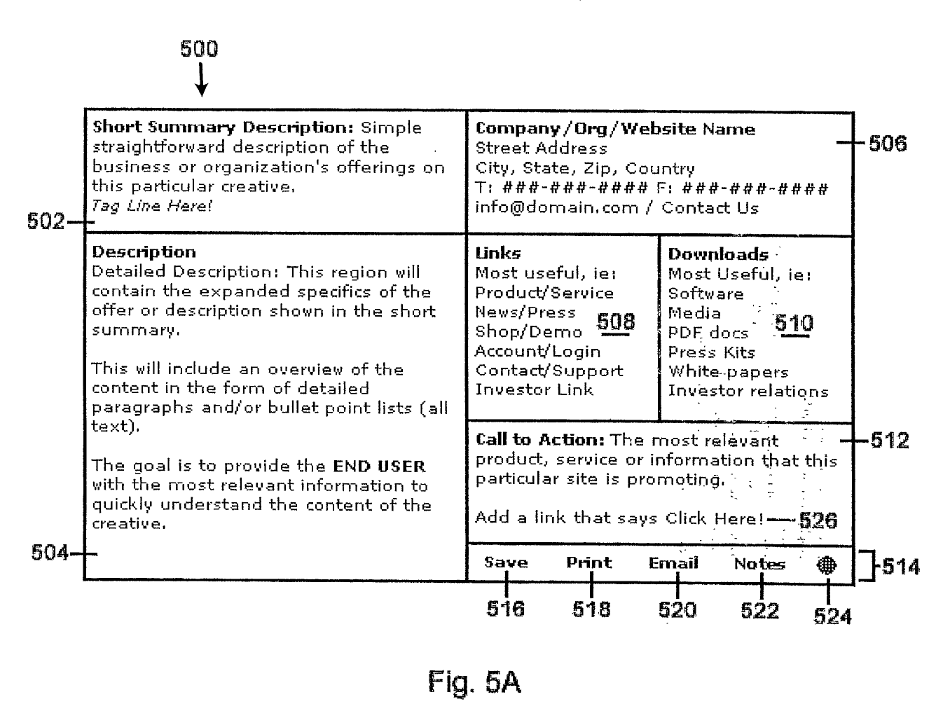

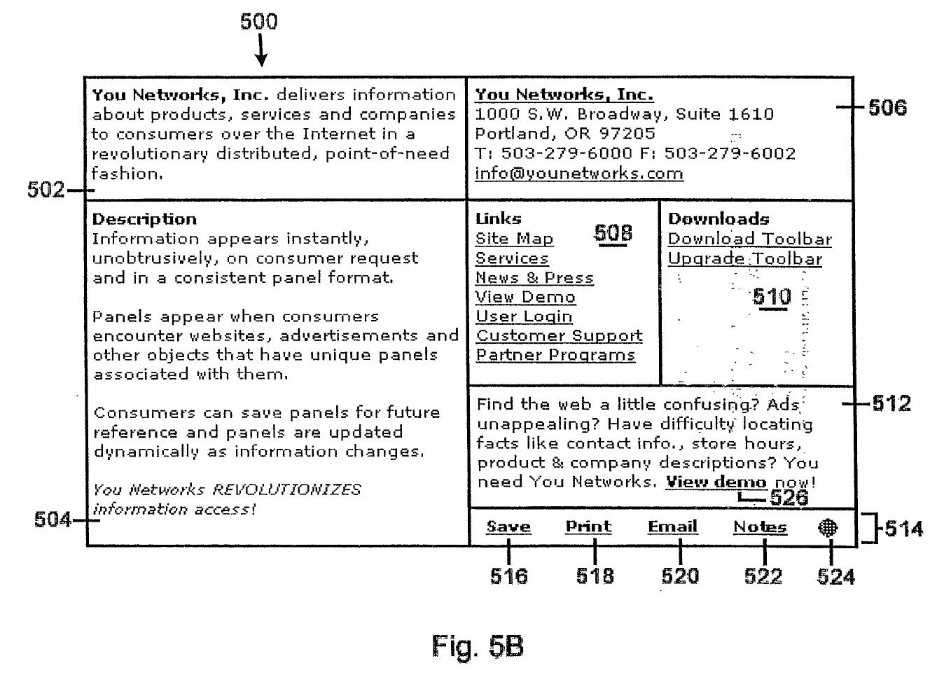

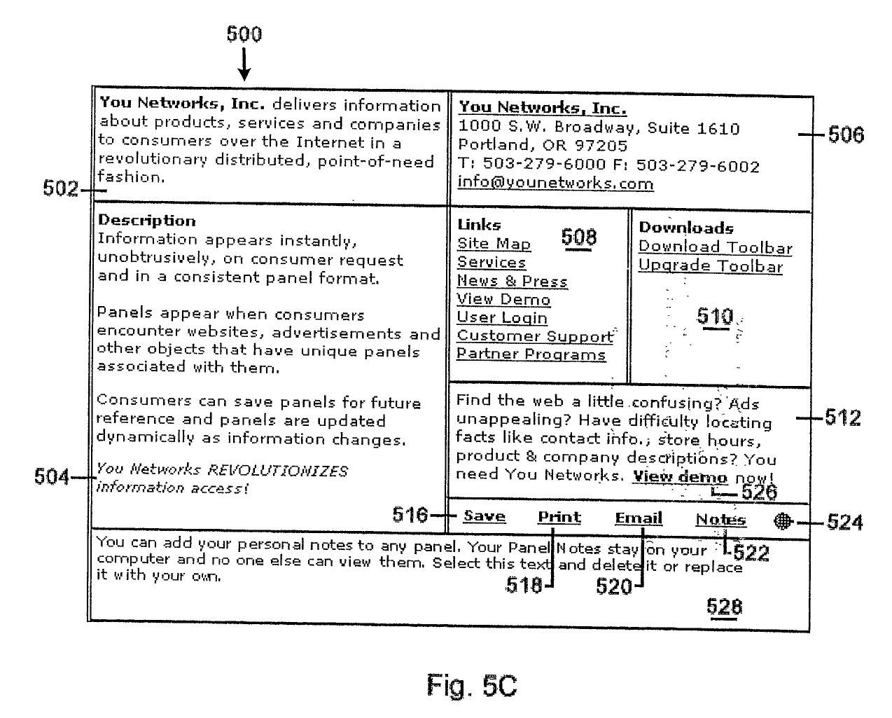

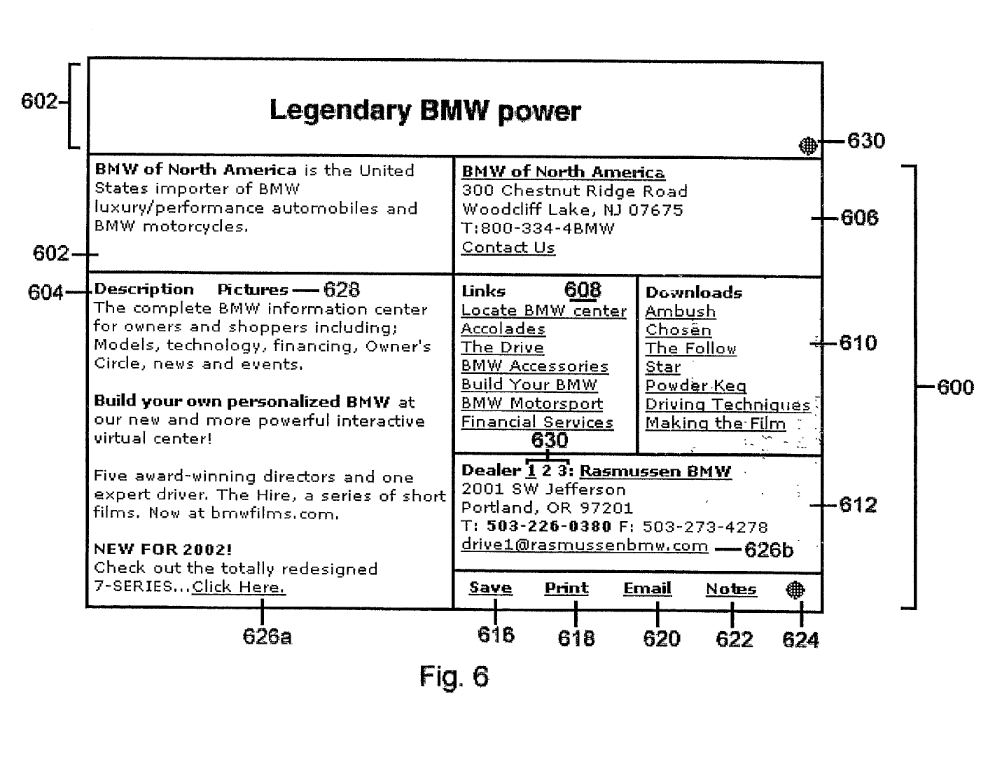

The preceding drawing figures illustrate how the present invention enables the display of supplemental content instantly, unobtrusively, and without interruption for the end user. Another aspect of the present invention is that the supplemental content display has a consistent appearance or format, even with supplemental content of disparate origin. The consistency is achieved by using standardized authoring and editing tools for the input of supplemental content, and a template display panel for the output or display of the supplemental content. A preferred embodiment adopts a consistent content display panel that adheres to a well-structured and standardized template. Illustrative supplemental content display panels are depicted in FIGS. 5A-5C and FIG. 6. While minor modifications to the display panel may be made to facilitate display of supplemental content on a wide variety of electronic display devices (such as PDAs, hand-held devices, Web phones, interactive televisions and various computing devices), it is preferred that the display panel configuration remain as consistent as possible. This promotes a uniform experience for the end user, and, over time, an end user develops an appreciation and anticipation for where particular content is located within the display panel. As will be obvious to those skilled in the art, various forms of coloration or gray-scale shading can be applied to the supplemental content panel, or individual sections, without departing from the general nature or scope of the present invention.

FIG. 5A illustrates a sample content panel 500. In a presently preferred embodiment, the content panel 500 is divided into seven sections. These include a summary section 502 for the supplemental content, a description section 504, a contact information section 506, a link section 508, a download section 510, a call-to-action section 512, and a control section 514. FIG. 5A illustrates the seven preferred sections of the display panel 500 with text describing the purpose of each section. FIG. 5B, however, illustrates actual supplemental content that may be supplied by a supplemental content provider or sponsoring entity as indicated in the contact information section 506 of the display panel 500.

The summary section 502 of a preferred supplemental content display panel 500 includes a brief description of the sponsoring entity's offerings for this supplemental content display. In an advertisement context, this can include a brief description of the ad or promotion. The summary section can also include one or more navigation links to provide additional functionality to enhance the viewing or interactive experience for the end user.

The description section 504 can include specifics of any offer or other supplemental content shown. The purpose of the description section 504 is to provide the end user the most relevant information to quickly understand the supplemental content. The description section 504C an also offer various links for the end user. While FIGS. 5A-5C depict text as the supplemental content, it is consistent with the present invention to supply additional types of content for display, such as static or dynamic graphics, flash or streaming media, audio or visual content, etc. The user can also be provided tabs or similar controls for selecting among alternative views of content in the description section 504. The description section 504 can also implement software modules providing discrete functionality. Examples of modules can include presentation of maps, driving directions, image albums, three-dimensional pictures, a/v content, etc.

The contact information section 506 includes contact information often of significant use to the end user. This information can include the name of the organization supplying the supplemental content, as well as a URL or direct link to its Web site presence. Address, telephone, fax, or e-mail options can also be provided for contacting the organization. Additionally, a link can be supplied whereby the user selecting the link is able to send mail directly to the sponsoring organization. Other types of contact information or communication technologies known to those skilled in the art may also be applied. The link section 508 can include links to additional content. Similarly, the download section 510 includes common downloadable information such as software, media, PDF documents, press kits, white papers, investor information, etc. The link section 508 and the download section 510 provide the end user the ability to access content in addition to the supplemental content 500. The supplemental content of the display panel 500 provides an end user immediate access to the most essential information. It is up the end user to pursue further information by way of links or downloads only if he so chooses. Accordingly, the supplemental content of the display panel 500 can be viewed inside the present display of the end user without the end user having to navigate to a new site. This minimizes the interruption to the end user.

A call-to-action section 512 can also be presented to the user to present the most relevant product, service, or other information with respect to the supplemental content in the presently displayed content panel 500. The call-to-action section 512 can include a link 526 (or multiple links), whereby the end user selects the call to action. For example, if a call-to-action offers a demonstration of a particular product or service (offered by the sponsoring organization in the summary section 502 or described with detail in the description section 504), the link 526 can transmit a request to view the demonstration online. Other types of calls-to-action could also be supported, depending on the characteristics or substance of the supplemental display panel 500.

The end user can also be presented a control section 514 offering various interactive abilities. For example, the end user can select a control to save the supplemental content display panel 516, print the panel 518, or e-mail the panel 520. A presently preferred embodiment of the supplemental content panel also presents the user with a control 522 for storing and editing notes or other information corresponding to the supplemental content. This information is supplied by the user himself. The user-supplied information can be saved to a predetermined storage location on the user's computer display device in a manner consistent with applicable security and user-privacy concerns. As illustrated in FIG. 5C, the information can be accessed from the predetermined storage location and displayed in a text field 528 responsive to the user selecting the appropriate control 522. The text field 528 can be displayed proximate to the supplemental content display panel for convenience to the user. This functionality would prove very useful to the end user, for example, if the supplemental content or corresponding digital content substrate required a user ID or password. The user can store the required information in their personal text field 528. Because the information remains on their display system, it is secure, and readily available if needed. Another example would be if a user wanted to store a personal review or critique to remind himself about the supplemental content or corresponding digital content substrate should they be subsequently encountered.

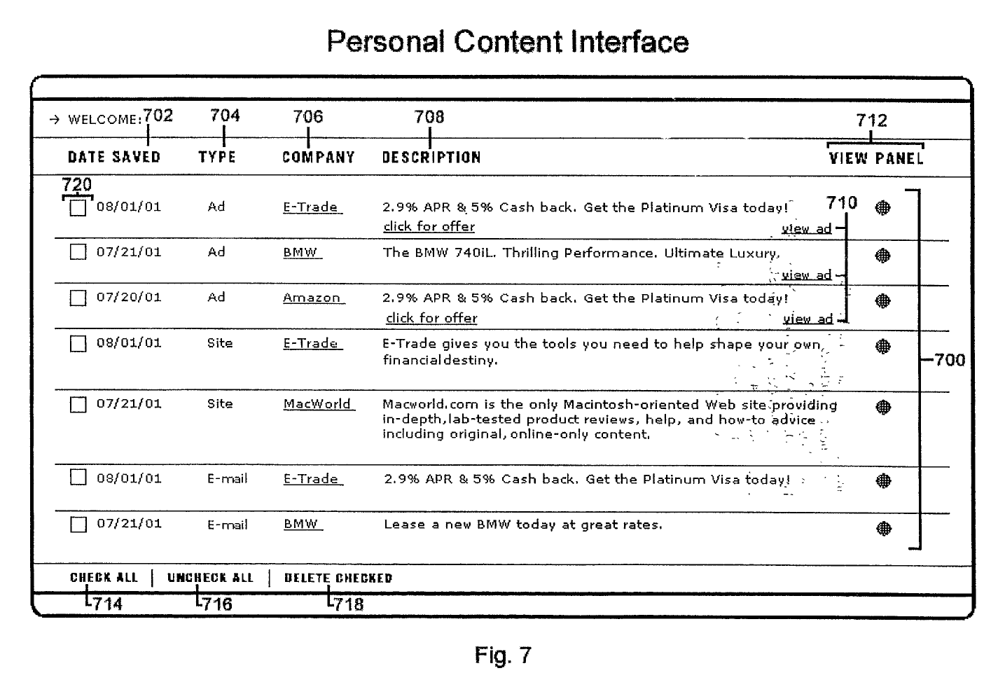

The control section 514 can also present a control 524 to afford the user access to a personal account via a personal content interface (described in further detail with respect to FIG. 7). The personal account can include supplemental content (as well as the corresponding digital content substrate) previously saved, printed, or otherwise selected. Upon selecting the appropriate control 524, the user display can be directed to a login site. If the user already has a valid account and a cookie stored to his display device, the user can be automatically logged in. If a user does not have a cookie on his system, he can be prompted for a user ID and password. If the user does not yet have a valid account, the login site can offer the user the ability to establish an account. Similarly, a user who does not yet have a valid account may be prompted to establish an account when he selects one of the other controls 516-522 from the control section 514 of the supplemental content display panel 500.

FIG. 6 illustrates a presently preferred supplemental content display panel. In FIG. 6, the supplemental content display panel 600 corresponds to digital content substrate comprising a banner advertisement 602. The content panel 600 includes the offer section 602, description section 604, sponsoring organization section 606, link section 608, download section 610, call-to-action section 612, and control section 614. These sections correspond to those depicted in FIGS. 5A-5C. After operation of the present invention as described with respect to FIGS. 3 and 4, an interactive indicator 630 is displayed atop the digital content substrate 602. When the user selects the interactive indicator 630, the supplemental content display panel 600 is immediately displayed for the end user. Similar to the display of the digital content indicator, the content panel 600 can be displayed in a transparent DHTML layer or new instantiation of a browser window overlying the display window that includes the digital content substrate 602. The user selects the interactive indicator via a user-input device, such as a mouse rollover or click event, a stylus selection (for band-held and similar devices), or a keystroke using a user-input device such as a keypad on a mobile phone or a keyboard for a computer system or ITV apparatus. In embodiments for which the interactive indicator can be audible (such as for mobile phones), the interactive indicator can be selected using voice activation technology of knowledge to those skilled in the art. To reduce interruption to the end user, display of the content panel 600 can be limited to occurring only when it is affirmatively requested by the end user. Accordingly, if an event such as a mouse rollover of the interactive indicator 630 is used to request the supplemental content, the content panel 600 will only be displayed so long as the mouse remains within the boundary defined around the interactive indicator for the mouse event or the boundary of the content panel 600 itself. As soon as the user's mouse rolls away from the interactive indicator 630 or content panel 600, the content panel 600 immediately disappears from display.

The interactive indicator symbol 630 is preferably semi-transparent or displayed intermittently (such as, for example, the blinking orb as depicted in FIG. 6). This helps mitigate occlusion of the underlying digital content substrate 602 display. By consistently using the same interactive indicator display, the presence of the supplemental content is always ascertainable by the end user, but the end user's view of the underlying digital content substrate is minimally impacted.

The various references numbers in the panel of FIG. 6 correspond to the similar references numbers for the corresponding sections of the panels in FIGS. 5A-5C. FIG. 6 also illustrates the concept of tabs in the various display panel sections. For example, the description section 602 includes a textual description that comprises mostly text with one link 626a. The description section 602 also includes a tab 628 for the user to view an image album (not shown) in the description section 602. This is an example of the addition of a module for specific functionality. A separate module could be alternatively or additionally added to the description section to provide a map to the content provider listed in the contact information section 606 of the panel 600. An audio or video module could also be added to display a TV ad in the description section. For each module made available, the user can be presented with a tab 628 to select among them. The use of tabs is also illustrated in the call-to-action section 612. There, numerical tabs 630 are presented to allow a user to choose among alternative call-to-action content items.

While FIG. 6 illustrates an embodiment of the present invention as applied to a banner ad, other forms of digital content substrate may also be included. These could include an interactive television display, an e-mail message, a Web site itself, or other forms of digital content. While the display for alternative forms of digital content substrate may vary slightly from that depicted in FIG. 6 with respect to banner ads, the common elements remain the same. For example, if the digital content substrate includes an interactive TV display, an e-mail, or a Web site, the interactive indicator can be placed atop a tool bar, file menu, corner of the screen or other suitable location. After selecting the interactive indicator display, a content panel similar to that illustrated as 600 in FIG. 6 will be displayed for the end user. In this manner, the present invention provides a consistent display experience for the end user, regardless of the networking media or display device employed.

FIG. 7 illustrates an example of a personal content interface. The personal content interface enables the end user to manage previously viewed, saved, printed, or emailed supplemental content display panels. A personal content interface can be accessible to an end user by selecting the appropriate control 524 from the display panel 500 of FIGS. 5A-5C. This control is also illustrated as 624 in the banner ad example of FIG. 6. A customized tool bar or tool bar link can also be added to the user's browser program to provide the user an alternative control to access the personal content interface. While components of the personal content interface can be customized to a particular end user, they typically include an indication of previously saved content panels 700. The saved material can be organized or sorted by the date saved 702, the type of digital content substrate to which this supplemental content corresponds 704, the sponsoring organization 706 (which may comprise a link to the organization's Web site), and the brief description of the supplemental content 708 (which may in turn comprise one or more links 722 with related information). An interactive display 710 can also be provided to allow the end user to access the digital content substrate directly from the personal content interface. Similarly, the end user can be provided controls 712 to view each saved supplemental content display panel. The personal content interface can also include a selection interface 720 to select for deletion one or more of the saved content panels, including controls to select all 714, unselect all 716, or delete 718 the saved content panels that were selected.

In an alternative embodiment, the supplemental content panel or corresponding digital content substrate could be saved for subsequent viewing without the panel having to be displayed in the first instance. For example, in a wireless data communications environment, a user may be operating a mobile phone with limited display abilities. One option would be to present the user with supplemental content in an alternate format than in the panels of FIGS. 5A-5C and FIG. 6 (to accommodate for the limited display capabilities). However, a presently preferred method would provide the user with an audible or visual interactive indicator signifying the presence of supplemental content. When the user reacts to the interactive indicator, either by voice command or by the mobile phone keypad, the panel and digital content substrate can be saved to the user's personal account. The user can subsequently view the entire panel, in its full format, from a personal computer or other device with greater display capabilities.

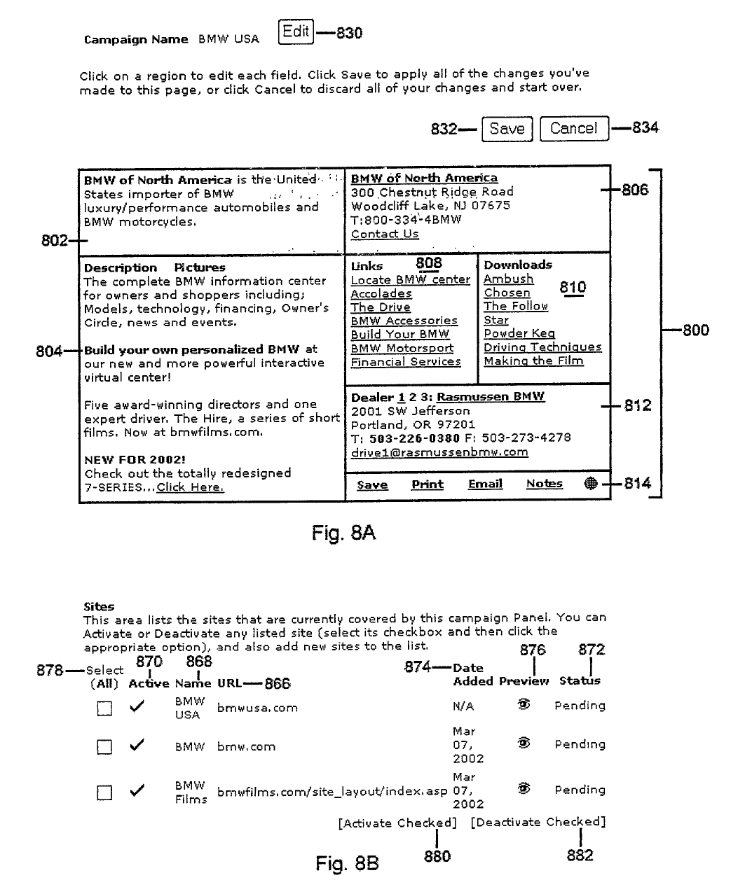

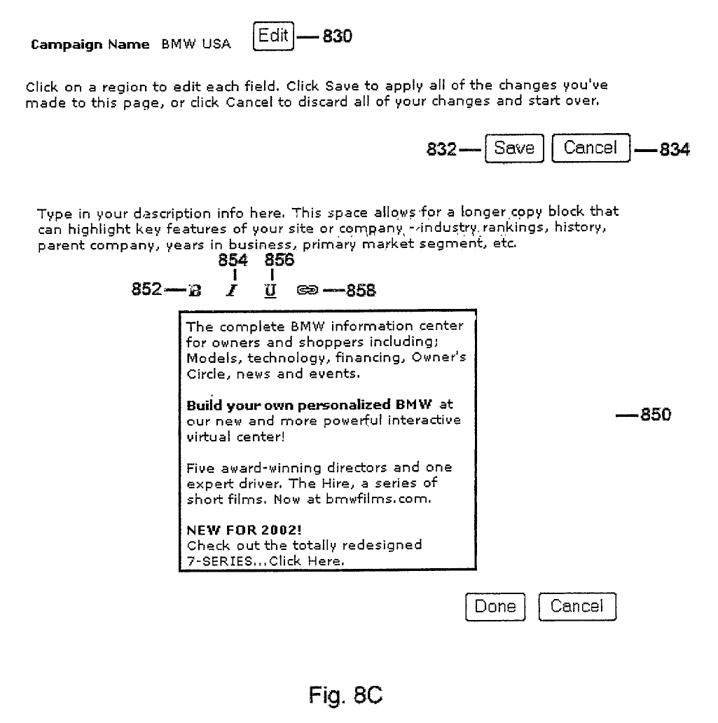

In addition to providing a consistent display of supplemental content, standardized supplemental content authoring and editing tools can be provided to help ensure a uniform display for the end user. FIGS. 8A-8C provide examples authoring and editing tools. For example, FIG. 8A employs a what-you-see-is-what-you-get type interface. This WYSIWYG-style of editing allows the originator of the supplemental content to view how the content will be displayed to the end user as it is being entered. In FIG. 8A, each section of the authoring interface 800 into which information can be added 802 through 814, directly corresponds to the similarly positioned sections of the content display panel of FIG. 6. In this way, the author of the supplemental content can determine and preview the ultimate appearance of the panel as he is editing. The originator of the supplemental content can also be presented controls to initiate editing 830, save all changes made 832, or disregard all changes made 834 and continue using the last-saved version of the panel.

When the originator of the supplemental content decides to edit the panel content, he can select a section to edit. In response to his selection, an editing dialog box can be presented. FIG. 8C depicts an editing dialog box presented for editing the description section 804 of the panel. With reference to FIG. 8C, the text can be added directly to the dialog box 850, and it will appear in the supplemental content panel (800 of FIG. 8A) as typed in the dialog box 850. The supplemental content originator can also choose among formatting controls to bold 852, italicize 854, or underline 856 text. A linking control 858 can be provided to establish links in the text or make external references to text files, Web sites, images, other graphics, or a/v presentations, or to apply functionality offered by pre-selected modules. When the user is done editing, the changes can be accepted by control 860 or rejected by control 862. An editing dialog box similar to 850 in FIG. 8C can be provided for editing each section of the panel 800 of FIG. 8A.

FIG. 8B presents an editing interface for an originator of supplemental content to specify the Web site or other forms of digital content substrate to which the supplemental content panel corresponds. The interface in FIG. 8B can list each digital content substrate or Web site on which it is displayed 866, an convenient name 868 for the digital content substrate 866, an indication of active status 870 for the supplemental content panel, additional status information 872, and the date the panel was added 874. To aid in editing the supplemental content, the editing entity can select a control 876 to preview each supplemental content panel. The editing entity can also alter the active status of each panel through controls to select one or more panels 878 and activate 880 or deactivate 882 the selected panels.

Due, in large part, to this convenient editing interface, as well as the overall system architecture and communications flow of the present invention (as described with respect to FIG. 1 through FIG. 4), the supplemental content can be easily updated, and the new version of the supplemental content display panel can be made immediately available throughout the network for all instances of the panel in a substantially instantaneous manner. In addition to the editing procedure described above, the originator of the supplemental content can also employ and automated editing process. This can allow the content within any of the sections of a panel to be automatically updated when new content becomes available. For example, some of the content in the links section 808 or downloads section 810 (as shown in FIG. 8A) can be set to update periodically (such as daily) with the most frequently visited pages or downloaded content from a Web site. In another example, the call-to-action section 812 could be automated to alternate between different choices periodically.

The preceding description illustrated several uses of modules in the supplemental content display panels. These modules offer predetermined functionality, such as the generation of maps, a/v content or presentations, image albums, etc. This additional functionality allows for the supplemental content panel to be customized or enhanced, but all within the formatting requirements necessary for maintaining a consistent user experience. Modular add-on capabilities can also include reporting functionality that is often of significant value to businesses conducting advertising campaigns over data communication networks. The advertising reporting can include statistics with respect to the number of impressions, click-throughs on a particular panel or section, display panel deployments, display panel open time, activity including location and time a user's mouse remains in a particular section of the display panel, downloads or links, and various other forms of reporting statistics known to those in the field of on-line marketing and advertising.

In the presently preferred Web-based embodiment, use of modules is consistent with an extensible Web-based application platform. An XML-based API allows customization of a content panel with the modules. Although they provide an ability to enhance content panels and afford customized functionality, the modules still maintain the intuitive structure and formatting necessary for a standard user experience. However, they can offer a richer, more satisfying user experience. Consistent with the present invention, a software development kit may also be made available to allow third parties to create new modules.

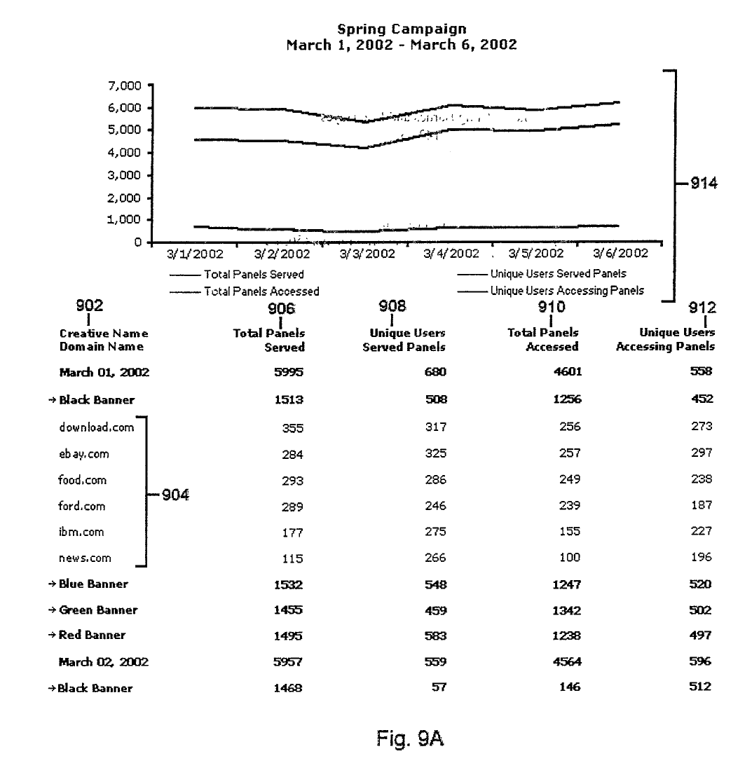

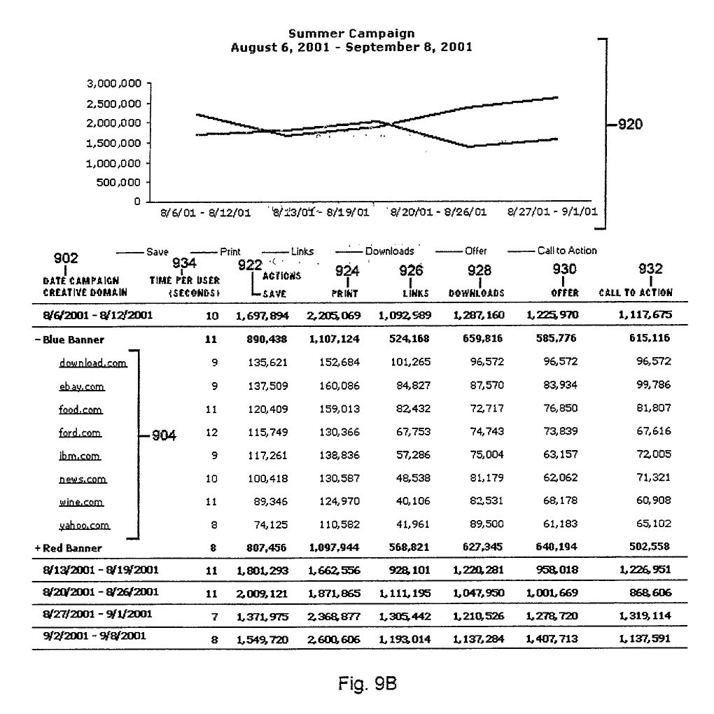

FIGS. 9A and 9B depict illustrative reporting displays that can be supplied to providers of digital content substrate or supplemental content in order to illustrate various statistics regarding how the end users have collectively reacted to the content display panel. FIG. 9A provides a panel summary report, and FIG. 9B provides a more detailed report on user interaction with panels. With reference to FIG. 9A, the panel summary report can list each digital content substrate 902 as well as various Web sites 904 where the digital content substrate is being presented to end users. The report can also provide statistics as to the total number of panels served 906, unique users being served panels 908 (to avoid redundancy of users in the reporting), total panels accessed 910, and unique users accessing panels 912. This panel summary report can be illustrated graphically 914.

Similar to the panel summary report of FIG. 9A, the detailed report of FIG. 9B can illustrate graphical results 920. The detailed report of FIG. 9B can present statistics pertaining to the time spent 934 interacting with a panel. Additionally, the report can include information on actions taken by the user. These actions can be further broken down into reports based on each section or control of the content display panel. For example, the reporting can include the number of times users elect to interact with a save control 922, print control 924, links 926, downloads 928, specific offer 930, or call-to-action 932 component of the each panel. These cumulative totals can provide useful information to suppliers of digital content substrate or supplemental content to determine what type of content is best received by an end user.

It will be obvious to those having skill in the art that many changes may be made to the details of the above-described embodiments of this invention without departing from the underlying principles thereof. The scope of the present invention should, therefore, be determined only by the following claims.

1. A method for delivering supplemental content to an end user on a data communications network, the method comprising the steps of:
(a) selecting a digital content substrate for presentation to an end user over a data communications network;
(b) determining a unique identifier for the digital content substrate;
(c) associating supplemental content with the unique identifier;
(d) detecting the unique identifier upon presentation of the digital content substrate to the end user;
(e) responsive to the detection of the unique identifier, providing the end user an interactive indicator tendering the supplemental content; and
(f) responsive to the end user selecting the interactive indicator, delivering the supplemental content to the end user.

2. The method of claim 1, wherein the unique identifier is a digital fingerprint.

3. The method of claim 1, wherein steps (d)-(f) are implemented by a software routine provided to the end user.

4. The method of claim 3, wherein the software routine is provided to the end user over the data communications network by a remote server.

5. The method of claim 3, wherein the software routine is embodied in a plug-in program.

6. The method of claim 3, wherein the software routine is embedded in the digital content substrate presented to the end user.

7. The method of claim 1, wherein the supplemental content is specified by an originator of the digital content substrate.

8. The method of claim 1, wherein the supplemental content is formatted into a standardized display panel.

9. The method of claim 8, wherein the supplemental content is formatted through a graphical user interface.

10. The method of claim 8, wherein:
the presentation of the digital content substrate includes displaying the digital content substrate to the end user; and
the delivering of the supplemental content formatted into the standardized display panel includes displaying the standardized display panel positioned proximate to the display of the digital content substrate.

11. The method of claim 10 wherein the displayed standardized display panel is positioned adjacent to the displayed digital content substrate so as to approximate a contiguous display.

12. The method of claim 8, further comprising at least one module for formatting the supplemental content.

13. The method of claim 12, wherein the at least one module provides predetermined functionality.

14. The method of claim 1, wherein the step of detecting the unique identifier includes:
monitoring data transmitted to the end user over the data communications network, the data including a bit sequence representing the digital content substrate;
determining a candidate unique identifier by applying a checksum procedure to the bit sequence; and
matching the candidate unique identifier to the unique identifier determined for the digital content substrate.

15. The method of claim 1, wherein said providing the interactive indicator includes displaying an unobtrusive symbol atop the digital content substrate.

16. The method of claim 15, wherein the unobtrusive symbol is displayed intermittently to mitigate occlusion of the digital content substrate.

17. The method of claim 1, further comprising the step of:
responsive to the detection of the unique identifier, transparently storing the supplemental content in a memory storage location for a display system of the end user; and
wherein said delivering the supplemental content includes reading the supplemental content from the memory storage location and displaying the supplemental content via the display system.

18. The method of claim 17, wherein the memory storage location comprises cache memory.

19. The method of claim 17, further comprising the step of associating an expiration date with the supplemental content stored in the memory storage location.

20. A method for providing on-demand display of supplemental content corresponding to a digital content substrate, the method comprising the steps of:
assembling supplemental content corresponding to a digital content substrate;
identifying the digital content substrate from among one or more display elements on a display of an electronic device;
displaying an indicator symbol atop the digital content substrate to indicate an availability of the supplemental content; and
displaying the supplemental content responsive to a user input associated with the indicator symbol.

21. The method of claim 20, wherein said displaying an indicator symbol does not alter the digital content substrate.

22. The method of claim 21, wherein the indicator symbol is displayed in a transparent display window overlaying the digital content substrate on the display of the electronic device.

23. The method of claim 22, wherein the display of the electronic device includes a Web browser program and the transparent display window is a DHTML layer.

24. The method of claim 22, wherein the display of the electronic device includes a Web browser program and the transparent display window is a new instantiation of a browser window by the Web browser program.

25. The method of claim 20, wherein the supplemental content is provided by an originator of the digital content substrate.

26. The method of claim 20, wherein said distinguishing the digital content substrate among the one or more display elements includes:
determining a digital fingerprint for each of the one or more display elements; and
comparing each determined digital fingerprint to a predetermined digital fingerprint for the digital content substrate.

27. The method of claim 20, wherein the indicator symbol is intermittently displayed so as not to occlude the digital content substrate.

28. The method of claim 20, wherein said assembling supplemental content includes formatting the supplemental content into a predetermined display template.

29. A method for uniformly displaying, via an electronic device, formatted content gathered from a plurality of disparate sources, the formatted content supplementing a plurality of digital content substrates, the method comprising the steps of:
selecting a plurality of digital content substrates;
determining a unique identifier for each of the plurality of digital content substrates;
providing an interface for gathering supplemental content corresponding to each of the digital content substrates and formatting the corresponding supplemental content into a corresponding plurality of content display panels, each content display panel employing to a standard display format;
providing a software routine to an electronic device for, upon the delivery of one or more of the digital content substrates to the electronic device for display:
identifying the one or more digital content substrates by detecting the corresponding unique identifier;
displaying an indicator symbol atop each of the identified one or more digital content substrates, the indicator symbol indicating availability of the corresponding one or more content display panels;
responsive to the selection of the indicator symbol displayed atop a first digital content substrate, displaying a first content display panel corresponding to the first digital content substrate.

30. The method of claim 29, wherein the unique identifier is a digital fingerprint.

31. The method of claim 29, wherein the indicator symbol is intermittently viewable so as not to occlude the one or more digital content substrates displayed by the electronic device.

32. The method of claim 29, wherein the indicator symbol is displayed without altering the one or more digital content substrate.

33. The method of claim 31, wherein the supplemental content for each content display panel is supplied by an entity supplying each corresponding digital content substrate.

34. The method of claim 33, further comprising the step of allowing the supplying entity to periodically update the supplemental content.

35. A system for delivering supplemental display content to an end user on a data communications network, the system comprising:
a primary content sever providing a displayed digital content substrate to an electronic display device of an end user;
a supplemental content server storing:
a known unique identifier representing a known digital content substrate; and
supplemental content corresponding to the known digital content substrate;
a software routine for comparing a candidate identifier, representing a graphic element on the electronic display device, to the known unique identifier, representing the known digital content substrate; and
an interactive indicator displayed atop the displayed digital content substrate in response to a favorable comparison of the candidate identifier and the known unique identifier, the interactive indicator for indicating an availability of the supplemental content, receiving a request from the end user to display the supplemental content, and, in response to the request, displaying the supplemental content.

36. The system of claim 35, wherein the interactive indicator is intermittently viewable so as to mitigate occlusion of the displayed digital content substrate.

37. The system of claim 35, wherein:
the displayed digital content substrate is displayed in a first display layer on the electronic device; and
the interactive indicator is displayed in a second display layer of the electronic device, the second display layer overlaying the first display layer.

38. The system of claim 35, wherein the digital content substrate is chosen from a group consisting of: a banner advertisement, a computer graphic, a Web site, a URL, a browser display screen, a streaming audio/video display, an e-mail message, a computer application display, and an iTV display.

39. The system of claim 35, wherein the unique identifier is a digital fingerprint.

40. The system of claim 39, wherein the digital fingerprint is a 64-bit checksum result.

41. The system of claim 40, wherein the digital content substrate comprises insufficiently few bits for the 64-bit checksum result, and the digital fingerprint is created by repeating and concatenating the insufficiently few bits until sufficient bits are available for the 64-bit checksum result.

42. The system of claim 35, wherein the known digital content substrate and the supplemental content are from a same source.

43. An electronic networking device software routine for displaying supplemental content corresponding to a digital content substrate, the routine comprising:
a first subroutine for identifying a unique identifier of a displayed digital content substrate;
a second subroutine for comparing the unique identifier to a stored unique identifier, the stored unique identifier representing a known digital content substrate having corresponding supplemental content; and
a third subroutine for displaying an interactive indicator symbol atop the displayed digital content substrate, detecting a user interaction with the interactive indicator, and, in response to the detected interaction, displaying the supplemental content.

44. The software routine of claim 43, wherein the software routine is delivered to an end user as a plug-in.

45. The software routine of claim 43, wherein the software routine is delivered to an end user as an interpreted script.

46. The software routine of claim 43, wherein the software routine is delivered to an end user as a JavaScript.

47. The software routine of claim 43, wherein the software routine is delivered to an end user as code embedded in the displayed digital content substrate.

48. The software routine of claim 43, wherein the third subroutine displays the interactive indicator symbol intermittently at a predetermined frequency.

49. The software routine of claim 43, wherein the supplemental content is displayed adjacent the displayed digital content substrate.

50. The software routine of claim 49, wherein:
the displayed digital content substrate is displayed in a first display layer; and
the interactive indicator symbol and the supplemental content are displayed in a second display layer overlaying the first display layer.

51. The software routine of claim 43, wherein the unique identifier is a digital fingerprint.
